(19) United States
(12) Patent Application Publication
(10) Pub. No.: US 2008/0220731 A1
(43) Pub. Date: Sep. 11, 2008

(54) REVERSE PATH OPTICAL LINK USING FREQUENCY MODULATION

(76) Inventor: LAMAR E. WEST, Maysville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/683,640

(22) Filed: Mar. 8, 2007

(51) Int. Cl. H04B 1/04

(52) U.S. Cl. 455/113

(57) ABSTRACT

Systems and methods of upstream communications using frequency modulation are disclosed. An exemplary method embodiment, among others, includes frequency modulating a communications signal, intensity modulating the frequency modulated signal, and applying that intensity modulated signal to a transmission medium. Also disclosed is a method of receiving the upstream signal including intensity demodulating the signal received from the transmission medium and frequency demodulating the resultant signal.

### TECHNICAL FIELD

The present disclosure is generally related to communications and, more particularly, is related to systems and methods for frequency modulated communications.

### BACKGROUND

Conventional analog reverse path optical links used in hybrid fiber/coax (HFC) networks often suffer from limited range capabilities. The transmitter optical output power and receiver optical input power is typically limited such that links are limited to distances within the range corresponding to transmitter optical output power and receiver optical input power.

Lasers used for reverse path signaling in the conventional approach to HFC network design are intensity modulated by the radio frequency electrical signals that contain information for transmission in the reverse path. Ideally the light intensity from these lasers is proportional to these electrical signals. The light is launched down a reverse path optical fiber and is attenuated by an amount that is a function of the length of that fiber. Radio frequency (RF) output power levels from conventional optical receivers are a function of the received optical input power. Variations in the length of optical fibers throughout the HFC network result in variations in the received optical power at the input of each optical receiver. Consequently, RF output power is manually adjusted at each optical receiver to compensate for variations in optical loss from link to link. Thus, a heretofore unaddressed need exists in the industry to address the aforementioned deficiencies and/or inadequacies.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a network diagram illustrating an exemplary embodiment of a subscriber television system with a plurality of set-top terminals (STTs) in operation.

FIG. 2 is a functional block diagram illustrating exemplary components of a headend, similar to a headend from FIG. 1.

FIG. 3 is a block diagram illustrating an embodiment of a hub for communication between a host and a secure processor in a STT, such as the hub from FIG. 1.

FIG. 4 is a graph of sub-carriers for downstream transmission in an exemplary system embodiment of FIG. 3.

FIG. 5 is a block diagram illustrating an exemplary embodiment of a downstream and upstream communication system for providing communication for the STT of FIG. 1.

FIG. 6 is a graph of sub-carriers for upstream transmission in an exemplary system embodiment of FIG. 3.

FIG. 7 is a block diagram illustrating an exemplary embodiment of a downstream and upstream communication system using frequency modulation for providing communication to the STT of FIG. 1.

FIG. 8 is a flow chart of an exemplary embodiment of a method of communication using frequency modulation.

### DETAILED DESCRIPTION

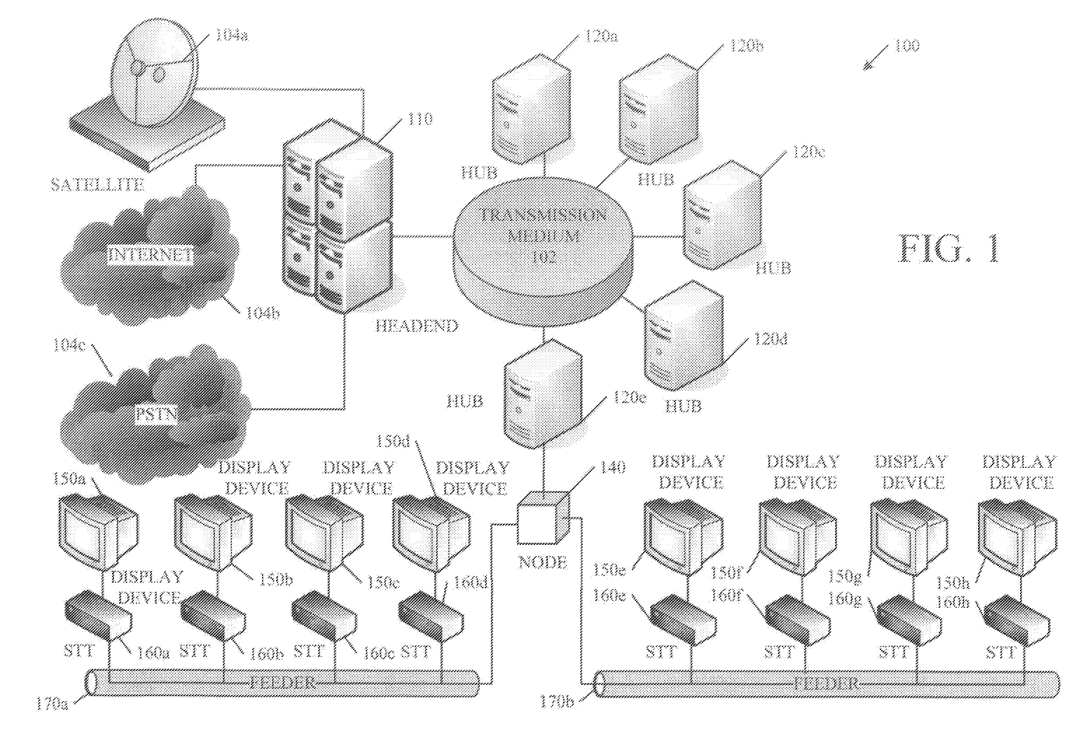

FIG. 1 is an embodiment of a data network for providing programming data to any of a plurality of set top terminals (STTs). More specifically, the components illustrated in FIG. 1 can generally be implemented as part of a subscriber television system (STS) 100. FIG. 1 shows a view of STS 100, which can take the form a network system that can deliver video, audio, voice and data services to STT users. Although FIG. 1 depicts a high level view of a STS 100, one can appreciate that any of a plurality of different cable television systems can tie together a plurality of networks into an integrated global network so that STT users can receive content provided from anywhere in the world.

STS 100 can be configured to provide programming signals as digitally formatted signals in addition to delivering analog programming signals. Further, STS 100 can be configured to support one way broadcast services as well as both one-way data services and two-way media and data services. The two way operation of STS 100 can allow for user interactivity with services, such as Pay-Per-View programming, Near Video-On-Demand (NVOD) programming according to any of several known NVOD implementation methods, View-on-Demand (VOD) programming (according to any of several known VOD implementation methods), and interactive applications, such as Internet connections and interactive media guide (IMG) applications.

STS 100 may also be configured to provide interfaces, network control, transport control, session control, and servers to access content and services, and to distribute content and services to STT users. As shown in FIG. 1, at least one embodiment of STS 100 includes headend 110 and a plurality of hubs 120 coupled to transmission medium 102. Transmission medium 102 can include any configuration of networking logic for providing communication capabilities between components in STS 100, including, but not limited to optical fiber, coaxial, cable, twisted pair. Additionally included in the nonlimiting example of FIG. 1 is node 140 coupled to hub 120e. Coupled to node 140 are feeders 170a and 170b. Feeders 170a and 170b can facilitate the communication of programming data to the plurality of set top terminals (STTs) 160a-160h, cable modems, voice interfaces 160a-160h. Display of the data received at STTs received can be provided by display devices 150a-150h coupled to, or integrated with STTs 160a-160h.

Additionally, the network can be configured to transmit media content to a headend for further transmission to users downstream in the network. Data provided by one or more content providers (such as via satellite 104a, Internet 104b, Public Switched Telephone Network (PSTN) 104c, etc.) can be communicated by the content provider to headend 110. From headend 110, the received data may then be communicated over transmission medium 102 to one or more hubs 120a-120e. The hubs 120 can be coupled to one or more nodes 140, each of which may serve a local geographical area. Node 140 is coupled to feeders 170a and 170b, which are coupled to network STTs 160. As one of ordinary skill in the art should understand, STS 100 shown in FIG. 1 is merely illustrative and should not be construed as implying any limitations upon the scope of the present disclosure.

One can appreciate that, although a single headend 110 is illustrated in FIG. 1, STS 100 can feature any of a plurality of headends 110. Similarly, other components may be added to STS 100 and/or omitted from STS 100, depending on the desired functionality.

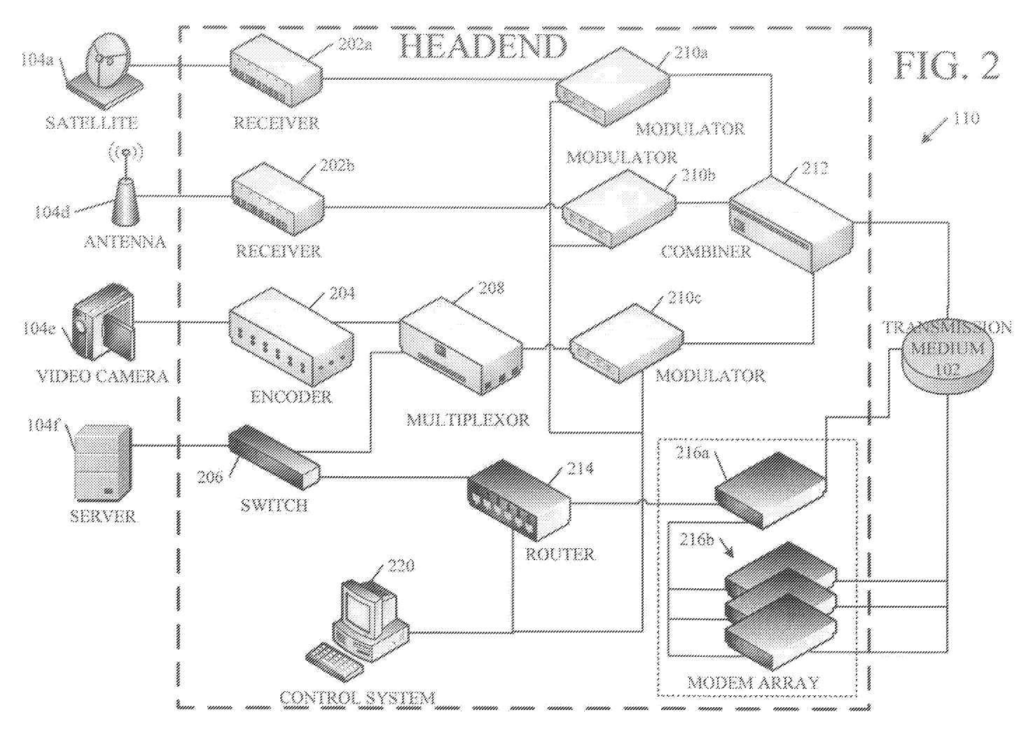

FIG. 2 is an embodiment of headend 110 that may be configured to provide programming data to any of a plurality of STTs 160, as well as to receive error data or other data from STTs 160, similar to headend 110 from FIG. 1. More specifically, FIG. 2 is a diagram illustrating various components that may be present at headend 110 for providing programming services to users of STTs 160. As discussed above, services provided by headend 110 may include broadcast programming, media-on-demand, as well as other services.

Included in headend 110 are receivers 202a and 202b, which are coupled to satellite 104a and antenna 104d, respectively. As discussed above, programming data can be received from any of a plurality of different sources including (but not limited to) those illustrated in FIGS. 1 and 2. As such, data can also be received from video camera 104e by encoder 204 and/or from server 104f by switch 206. Multiplexor 208 is coupled to encoder 204 and switch 206. Additionally, switch 206 is coupled to router 214. Also coupled to router 214 is control system 220. Router 214 is also coupled to a modem array, which may include modem 216a and modems 216b. Modems 216a, 216b may be configured as quadrature phase shift key (QPSK) and quadrature amplitude modulation devices (QAM) among other modulation mechanisms, and may be grouped together in a Cable Modem Termination System (CMTS) using various radio frequency signaling methods. These signaling methods may comprise the transmission of downstream radio frequency signals and the reception of upstream radio frequency signals.

These signals are sent to and received from the STTs, cable modems, voice interfaces, and other devices throughout the HFC network. Modems 216 can be configured to be responsible for transporting out-of-band Internet Protocol (IP) data traffic between distribution headend 110 and at least one STT 160, which can send data to at least one display device 150. Data from modem 216 can be routed by headend 110. Headend 110 can also be responsible for delivering upstream traffic (e.g., application data traffic) to the various server applications associated with headend 110. Although reference is made to STTs 160 in exemplary embodiments, the systems and methods enclosed herein also apply to cable modems that are connected to computers, voice interfaces for telephony, and telemetry electronics for monitoring network performance, as well as other devices that utilize two-way communication over an HFC network.

Additionally, headend 110 may include modulators 210a, 210b, and 210c, which are coupled to receiver 202a, receiver 202b, and multiplexor 208, respectively (as well as control system 220). Modulators 210a-210c are coupled to combiner 212. Combiner 212, as well as modem array 216 are coupled to transmission medium 102.

While not included in the nonlimiting example of FIG. 2, other elements may also be included in headend 110 for providing various services to users of STTs 160. Examples of such components can include components for providing management, monitoring, and/or control of elements and broadcast services of STS 100 as provided to users. In one implementation, headend 110 can include one or more components to facilitate the insertion of in-band broadcast file system (BFS) data into an MPEG-2 transport stream (and/or other transport streams) that is broadcast and received via the communication interface and tuner system (not shown) of each STT 160. Headend 110 can also be configured to utilize a Digital Storage Media Command and Control (DSMCC) protocol to set up and maintain Media on Demand (MOD) sessions (e.g., video on demand). Some embodiments may also be configured to process user to network (U-N) session signaling messages, manage allocation of session-related network resources, support network management operations, act as a point of contact to STS 100 for STT 160 to establish individual sessions, and support MOD services.

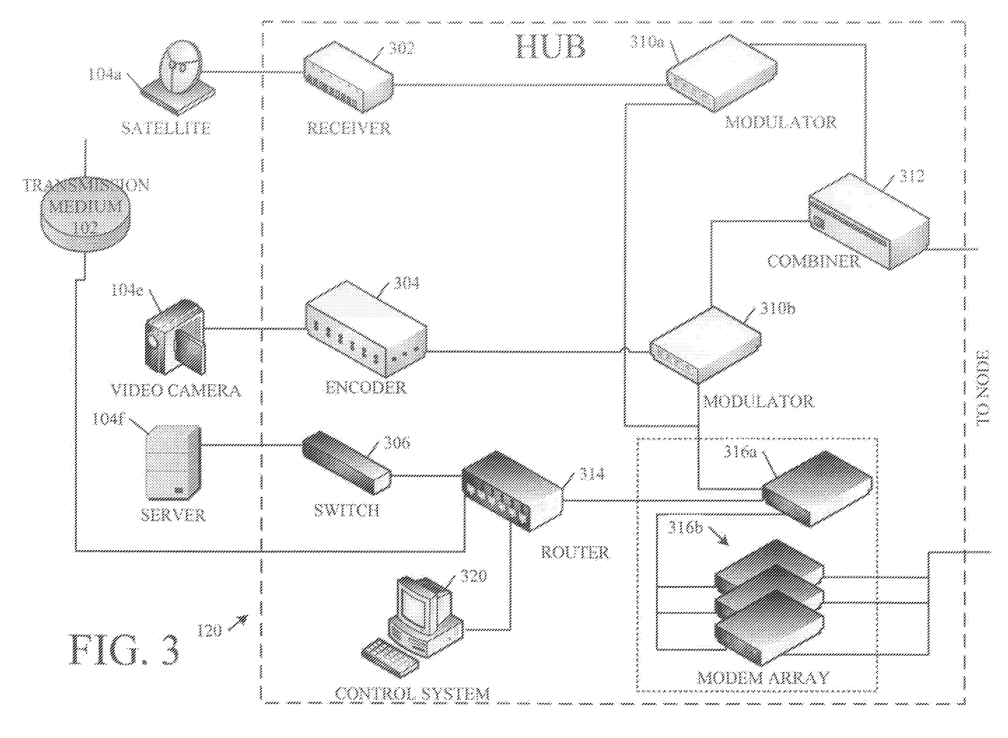

FIG. 3 is an embodiment of hub 120 that may be configured to facilitate communication of data between STT 160 and headend 110 from FIGS. 1 and 2. Similar to headend 110 configuration from FIG. 2, hub 120 can include one or more of receiver 302, encoder 304, and switch 306 for receiving data from various sources, such as satellite 104a, video camera 104e, and server 104f. Additionally, hub 120 may include router 314 that may be coupled to switch 306, control system 320, and transmission medium 102. As one of ordinary skill in the art should understand, data received from transmission medium 102 can originate from headend 110, another hub 120, node 140, or other network component, such as those illustrated in FIG. 1.

Additionally included in the nonlimiting example of hub 120 from FIG. 3 are modulators 310a and 310b. Modulators 310a, 310b can be coupled to receiver 302 and encoder 304, as well as to modems 316a and 316b of a modem array. Also coupled to modem array 316 is router 314. Data from combiner 312 and modem array 316 may be sent to and/or received from node 140 (FIG. 1) and/or other components associated with network 100.

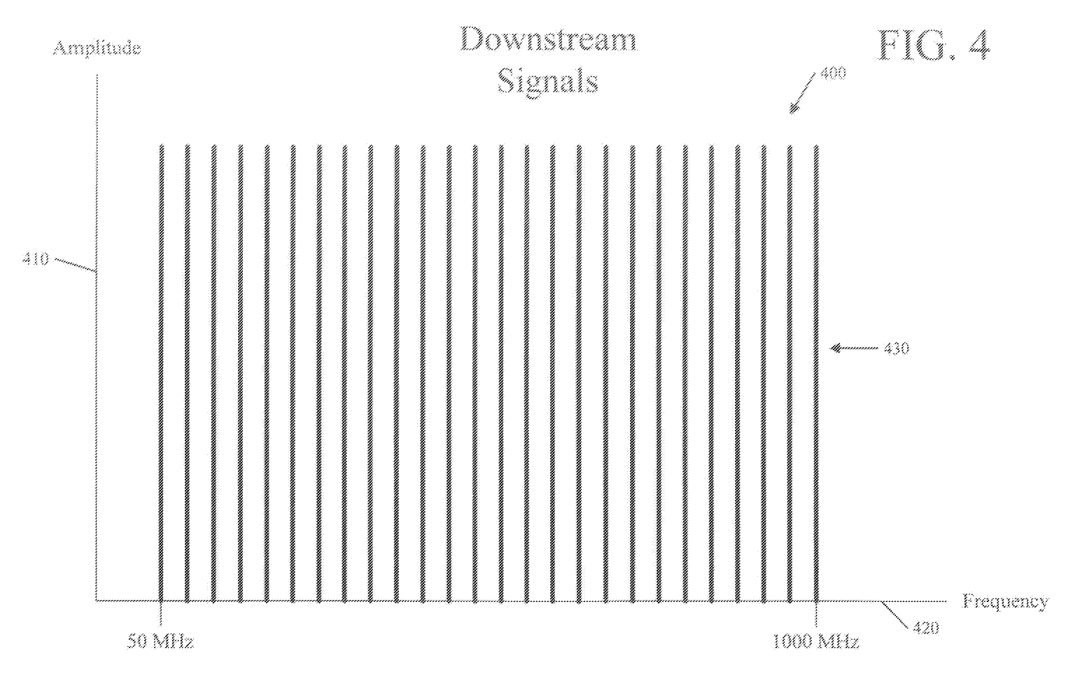

Although frequency modulation (FM) has been widely used for transmission of audio signals, FM may be used for many other functions, including modulation functions in headend 110 and node 140. Hub 110 or headend 160 may arrange a group of signals, which are signal sources for downstream signals, for preparation for downstream transmission to a subscriber's home or business, or other intended receiver of the downstream signal. This group of signals may be combined together into one or more composite signals using RF sub-carrier multiplexing. For example, each TV channel has its own RF sub-carrier on an individual frequency. There are sub-carriers that carry digital information such as non-limiting examples of digital television, high-speed data, etc. FIG. 4 provides graph 400 of amplitude 410 versus frequency 420. In downstream communications, several RF sub-carriers 430 may be employed, typically in the range of 50 MHz to 1000 MHz.

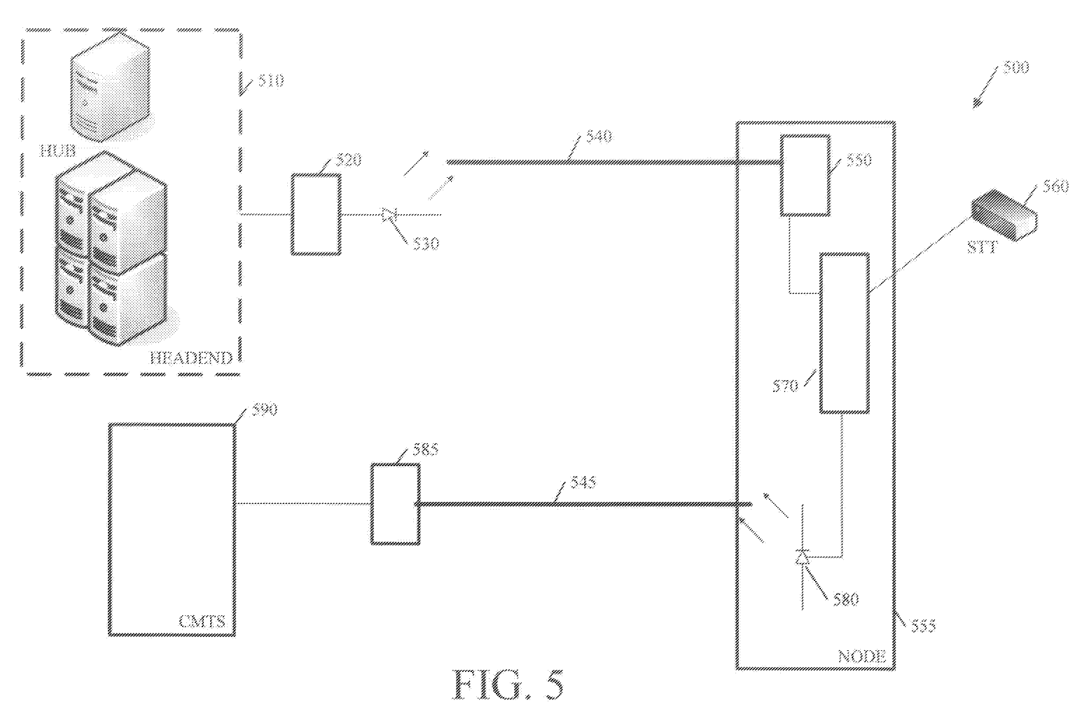

FIG. 5 provides an exemplary embodiment of communication system 500 including downstream components hub and/or headend 510, RF subcarrier multiplexer 520, modulator 530, transmission medium 540, node 555, and STT 560. Node 555 includes, in one embodiment, demodulator 550, filter 570, and modulator 580. RF sub-carriers 430 are then used at the output of headend and/or hub 510 to modulate the multiplexed signal with modulator 530. Non-limiting examples of modulator 530 include an intensity modulator and an amplitude modulator. The output of modulator 530 is then provided to transmission medium 540, which, as a non-limiting example, comprises an optical fiber. The signal then propagates to node 555. In one non-limiting example, node 555 may be located on a telephone pole. In node 555, receiver 550 converts the intensity modulated signal back into an electrical RF signal, which is typically sent over coaxial cable to STT 560 at a subscriber's home.

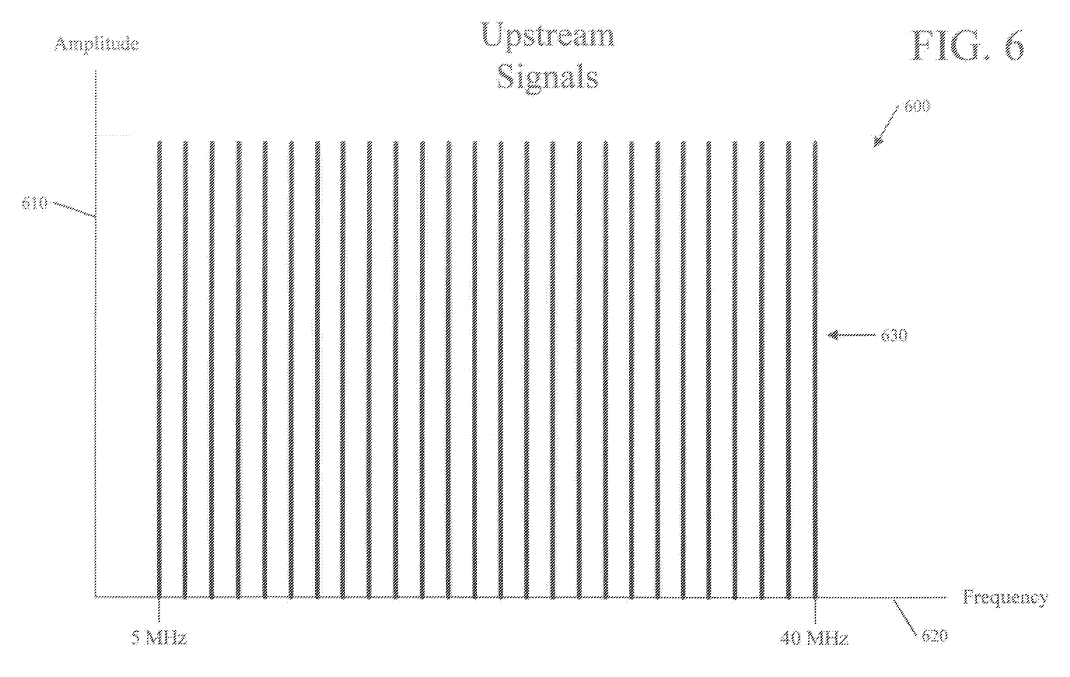

For example, modulator 530 may convert an RF signal to an optical signal, and then, at node 555, the optical signal is converted back to an RF or electrical signal. Two-way communications utilize both downstream communications from headend/hub 510 to STT 560 and upstream communication from STT 560 back to headend/hub 510 or to cable modem termination system (CMTS) 590.

Whereas the downstream signals are sent, in one implementation, in the 50 MHz to 1000 MHz band, the upstream signals are typically sent in the 5 MHz to 40 MHz band (e.g., international systems may use other frequency bands). FIG. 6 provides graph 600 of amplitude 610 versus frequency 620. In upstream communications, RF sub-carriers 630 are typically in the range of 5 MHz to 40 MHz for transmission of signals upstream from STT 560. Filter 570 is configured, in one embodiment, as a diplex filter for passing downstream signals to SST 560 and for passing upstream signals from SST 560 to CMTS 590.

On the upstream side, a second modulator 580 in node 555 modulates the RF electrical signal for propagation along transmission medium 545. The signal is received by receiver 585, where it may be converted back to an electrical signal for CMTS 590.

One or more problems may occur with this approach. One problem is the reach or range of the transmission medium. There may be a limited amount of fiber distance. With intensity modulation, for example, as the signal propagates down the fiber, the signal is attenuated and the receiver (e.g., node 555) has a limit at which it can no longer receive a meaningful signal due to reduced signal to noise ratio. A repeater may be used. However, a repeater may not be practical because a surface (e.g., a street) may have to be disturbed, electronic components may need to be remotely added to the system, and/or power may need to be provided to the electronic components, among other reasons. Another problem is that the output signal level varies in amplitude with the transmission distance.

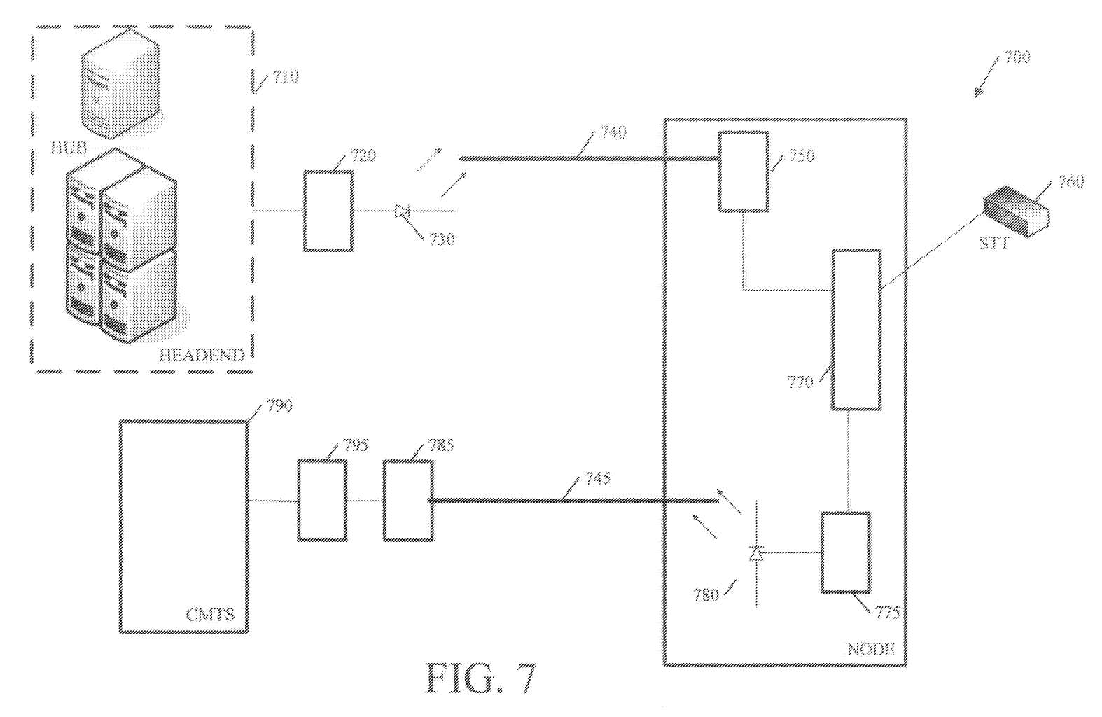

To overcome these and/or other potential problems, instead of directly modulating the optical signal with the upstream RF signal, the RF upstream signal is first modulated by a wide-band FM modulator. FIG. 7 provides an exemplary embodiment of communication system 700 using upstream FM modulation. Communication system 700 includes downstream components hub and/or headend 710, RF subcarrier multiplexer 720, modulator 730, transmission medium 740, node 755 (which includes demodulator 750, filter 770, FM modulator 775, and modulator 780), and STT 760. RF sub-carriers 430 are used to modulate the multiplexed signal with modulator 730. Non-limiting examples of modulator 730 include an intensity modulator and an amplitude modulator. The output of modulator 730 is then provided to transmission medium 740 (e.g., an optical fiber). The signal then propagates to node 755. In node 755, receiver 750 converts the intensity modulated signal back into an electrical RF signal, which is typically sent over coaxial cable to STT 760 at a subscriber's home.

For example, modulator 730 may convert an RF signal to an optical signal, and then, at node 755, the optical signal is converted back to an RF or electrical signal. Two-way communications utilize both downstream communications from headend/hub 710 to STT 760 and upstream communication from STT 760 back to headend and/or hub 710 or to cable modem termination system (CMTS) 790. CMTS 790 may be included as a part of headend and/or hub 710 in some embodiments.

In one implementation, whereas the downstream signals are sent in the 50 MHz to 1000 MHz band, the upstream signals are sent in the 5 MHz to 40 MHz band. Referring to FIG. 6, in upstream communications, RF sub-carriers 630 are typically in the range of 5 MHz to 40 MHz for transmission of signals upstream from STT 760. Filter 770 is configured, in one embodiment, as a diplex filter for passing downstream signals to SST 760 and for passing upstream signals from SST 760 to CMTS 790. On the upstream side in the embodiment of FIG. 7, FM modulator 775 first frequency modulates the upstream signal onto an RF carrier. The output of FM modulator 775 is then provided to modulator 780 (which may be in node 755), which intensity modulates a laser to produce an optical signal for propagation along transmission medium 745. The signal is received by receiver 785, where it may be converted back to an electrical signal. FM demodulator 795 then FM demodulates the signal, thereby recovering RF sub-carriers 630 for propagation to CMTS 790.

In one exemplary embodiment, the carrier frequency (F_{c}) is between 1 GHz and 1.5 GHz. A wide-band FM modulated signal may be intensity modulated with a laser to produce an optical signal for transmission across transmission medium 745. In one non-limiting example, the FM carrier may be transmitted over optical fiber. The signal may be received by receiver 785 and then FM demodulator 795, which is communicatively coupled to CMTS 790. With an FM signal, the signal amplitude can drop much lower and still maintain data integrity at CMTS 790 with acceptable signal-to-noise ratio.

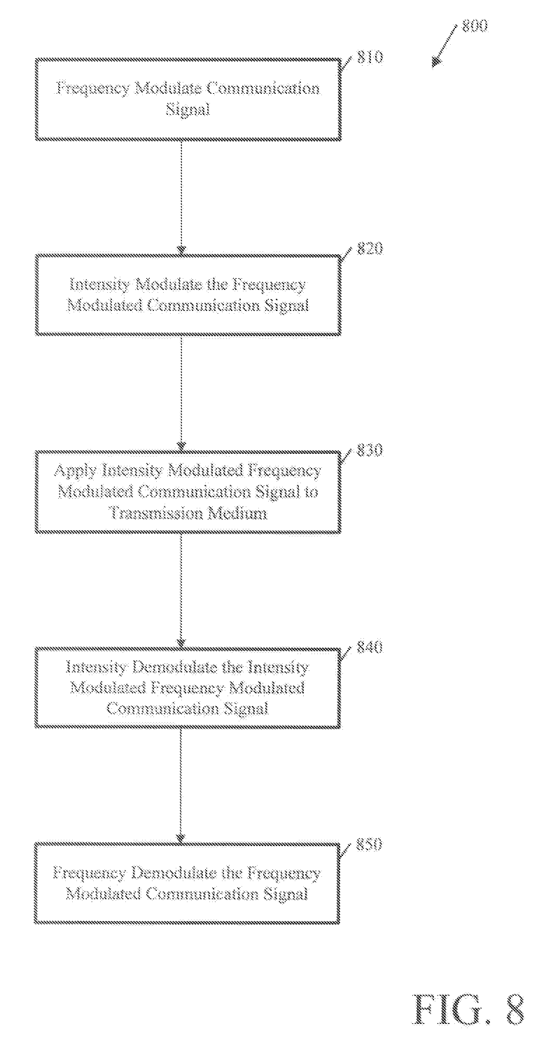

FIG. 8 provides flow chart 800 for an exemplary embodiment of a method of reverse path link using frequency modulation. In block 810, a communication signal is frequency modulated. In block 820, the frequency modulated signal is intensity modulated. In block 830, the intensity modulated, frequency modulated communication signal is provided to a transmission medium. After the signal propagates across the transmission medium, in block 840, the intensity modulated, frequency modulated communication signal is intensity demodulated. In block 850, the frequency modulated communication signal is frequency demodulated.

Embodiments of the present disclosure can be implemented in hardware, software, firmware, or a combination thereof. In at least one exemplary embodiment, the frequency modulation may be implemented in software or firmware that is stored in a memory (e.g., in a digital signal processor (DSP)) and that is executed by a suitable instruction execution system. If implemented in hardware, as in an alternative embodiment, the frequency modulation may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

Embodiments of a frequency modulation program, which comprises an ordered listing of executable instructions for implementing logical functions, may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any mechanism that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present disclosure includes embodying the functionality of the preferred embodiments of the present disclosure in logic embodied in hardware or software-configured mediums. It should be emphasized that the above-described embodiments of the present disclosure are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, at least the following is claimed:

1. A communication system comprising:
a transmitter in a reverse path of a communication system comprising:
a first modulator configured to frequency modulate a radio frequency (RF) electrical signal; and
a second modulator configured to intensity modulate an optical signal with the radio frequency (RF) electrical signal.

2. The communication system of claim 1, wherein the first modulator comprises a wideband frequency modulation modulator.

3. The communication system of claim 1, wherein the second modulator comprises at least one of a laser and an intensity modulator.

4. The communication system of claim 1, further comprising a transmission medium communicatively coupled to the second modulator, the second modulator configured to transmit the intensity modulated frequency modulated RF electrical signal.

5. The communication system of claim 4, wherein the transmission medium comprises optical fiber.

6. The communication system of claim 1, further comprising an optical receiver configured to demodulate the intensity modulated frequency modulated RF electrical signal to produce a frequency modulated RF electrical signal.

7. The communication system of claim 6, wherein the optical receiver comprises a photodiode.

8. The communication system of claim 3, further comprising a frequency modulation demodulator communicatively coupled to an optical receiver configured to frequency modulation demodulate the frequency modulated RF electrical signal to produce an RF electrical signal.

9. The communication system of claim 1, wherein the transmitter is further configured to transmit upstream in a cable television system from a node to a headend or hub.

10. A method comprising:
frequency modulating a communications signal;
intensity modulating an optical signal with the frequency modulated (FM) communications signal; and
applying the intensity modulated optical signal to a transmission medium.

11. The method of claim 10, wherein frequency modulating comprises frequency modulating with a wideband FM modulator.

12. The method of claim 10, wherein intensity modulating comprises intensity modulating with at least one of a laser and an intensity modulator.

13. The method of claim 10, wherein the transmission medium comprises optical fiber.

14. The method of claim 10, further comprising:
receiving the intensity modulated frequency modulated communications signal from the transmission medium;
intensity demodulating the intensity modulated frequency modulated communications signal; and
frequency demodulating the frequency modulated communications signal.

15. The method of claim 14, wherein intensity demodulating comprises intensity demodulating with a photodiode.

16. A computer readable storage medium comprising:
logic configured to frequency modulate a communications signal;
logic configured to intensity modulate an optical signal with the frequency modulated (FM) communications signal; and
logic configured to apply the intensity modulated optical signal to a transmission medium.

17. The computer readable storage medium of claim 16, wherein the logic configured to frequency modulate comprises logic configured to modulate on a digital signal processor.

18. The computer readable storage medium of claim 16, further comprising:
logic configured to receive the intensity modulated frequency modulated communications signal from the transmission medium;
logic configured to intensity demodulate the intensity modulated frequency modulated communications signal; and
logic configured to frequency demodulate the frequency modulated communications signal.

19. The computer readable storage medium of claim 18, wherein the logic configured to frequency demodulate comprises logic configured to demodulate on a digital signal processor.
